(19) United States
(12) Patent Application Publication
(10) Pub. No.: US 2007/0076684 A1
(43) Pub. Date: Apr. 5, 2007

(54) Apparatus and method for relaying ranging messages in multi-hop relay broadband wireless access communication system

(75) Inventors: Sung-Jin Lee, Seoul (KR); Pan-Yuh Joo, Seoul (KR); Jung-Je Son, Seongnam-si (KR); Jae-Weon Cho, Suwon-si (KR); Hyoung-Hyu Lim, Seoul (KR); Yeong-Moon Son, Anyang-si (KR); Mi-Hyun Lee, Seoul (KR); Hyun-Jeong Kang, Seoul (KR); Song-Nam Hong, Seoul (KR); Young-Ho Kim, Suwon-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/542,934

(22) Filed: Oct. 4, 2006

(30) Foreign Application Priority Data
Oct. 4, 2005 (KR) 2005-92965

(51) Int. Cl. H04J 3/06

(52) U.S. Cl. 370/350; 370/335; 370/342

(57) ABSTRACT

Provided is an apparatus and method for relaying Ranging messages in a multi-hop relay BWA system. A RS receives a Ranging Request message from an MS, reconfigures the received Ranging Request message into a Relay Ranging Request message, and transmits the Relay Ranging Request message to a serving BS. Thereafter, the RS receives a Relay Ranging Response message from the serving BS, reconfigures the Relay Ranging Response message into a Ranging Response message, and transmits the Ranging Response message to the MS.

### PRIORITY

This application claims priority under 35 U.S.C. § 119 to an application entitled “Apparatus and Method for Relaying Ranging Messages in Multi-Hop Relay Broadband Wireless Access Communication System” filed in the Korean Intellectual Property Office on Oct. 4, 2005 and allocated Serial No. 2005-92965, the contents of which are incorporated herein by reference.

### BACKGROUND OF THE INVENTION

1. Field of the Invention

The present invention relates generally to a cellular communication system, and in particular, to an apparatus and method for relaying Ranging messages in a multi-hop relay Broadband Wireless Access (BWA) system in which a Relay Station (RS) is installed between a Mobile Station (MS) and a serving Base Station (BS).

2. Description of the Related Art

Research is being conducted to provide services having various Quality-of-Services (QoSs) with a data rate of about 100 Mbps in the fourth-generation (4G) communication system which is the next-generation communication system. The 4G communication system is evolving to provide a high-rate data service that supports mobility and QoS in a BWA system such as a Local Area Network (LAN) system and a Metropolitan Area Network (MAN) system. Typical examples of the above system are an Institute of Electrical and Electronics Engineers (IEEE) 802.16d system and an IEEE 802.16e system.

The IEEE 802.16d system and the IEEE 802.16e system use an Orthogonal Frequency Division Multiplexing (OFDM)/OFDM Access (OFDMA) scheme. The IEEE 802.16d system does not consider the mobility of a Subscriber Station (SS) at all and considers only a single cell structure. On the other hand, the IEEE 802.16e system considers the mobility of an SS. Hereinafter, an SS with mobility will be referred to as “Mobile Station (MS)” or “Mobile Subscriber Station (MSS)”.

FIG. 1 is a schematic block diagram of an IEEE 802.16e system.

Referring to FIG. 1, the IEEE 802.16e system has a multi-cell structure. The IEEE 802.16e system includes a cell 100, a cell 150, a BS 110 managing the cell 100, a BS 140 managing the cell 150, and a plurality of MSs 111, 113, 130, 151 and 153. The signal exchange between the BSs 110 and 140 and the MSs 111, 113, 130, 151 and 153 is performed using an OFDM/OFDMA scheme. The MS 130 is located in a boundary region (i.e., a handover region) between the cells 100 and 150. When the MS 130 moves into the cell 150 of the BS 140 during communication with the BS 110, a serving BS of the MS 130 is changed from the BS 110 to the BS 140.

FIG. 2 is a message flow diagram illustrating a ranging procedure in an IEEE 802.16e system.

A serving BS must acquire uplink (UL) time synchronization of an MS for communication with the MS. A signal transmitted from the MS for the acquisition of the UL time synchronization is called a “Ranging message”.

Referring to FIG. 2, an SS 201 receives a UL channel descriptor (UCD) message containing UL channel information for communication from a serving BS 203 in step 204. Using the UCD, the SS 201 performs an initial connection process, which is called a “ranging process”.

In the ranging process, the SS 201 transmits a Ranging Request message RNG-REQ to the serving BS 203 in step 205 and the serving BS 203 transmits a Ranging Response message RNG-RSP to the SS 201 in response to the Ranging Request message in step 207.

FIG. 5 is a diagram illustrating the format of the Ranging Request message that is transmitted from an SS to a BS in the IEEE 802.16e system.

Referring to FIG. 5, a Management Message Type field has a value of ‘4’ to indicate that the present message is a Ranging Request message. A Downlink (DL) Channel ID field indicates which DL channel is used to receive the UCD message in step 204 of FIG. 2. A TLV (Type/Length/Value) encoded information field indicates encoded information including an SS Medium Access Control (MAC) Address, a Requested Downlink Burst Profile, an MAC Version, Ranging Anomalies and AAS (Adaptive Antenna System) Broadcast Capability. A SS Medium Access Control (MAC) Address field contains a MAC layer address of the SS, which is used as an identifier (ID) for identifying the SS. A Requested Downlink Burst Profile field includes a 0-3 bit section and a 4-7 bit section. The 0-3 bit section indicates a DL interval usage code (DIUC) of a DL burst profile which is used by the SS to request predefined formats for the exchange of physical channel signals, such as a modulation format and an error correction format that are predefined for DL data. Based on this information, the BS transmits data to the SS over a predefined type of DL physical channel. The 4-7 bit section indicates the four least significant bits (LSBs) of a Configuration Change Count field in the UCD message which is used for the ranging request. A MAC Version field indicates the version of a MAC layer that is to be used by the SS. A Ranging Anomalies field includes information about whether the SS transmits a signal for connection to the BS at maximum power or at minimum power. Accordingly, the SS can use the Ranging Anomalies field as a response to a TX/RX power Up/Down command that may be received from the BS for adjustment of the time information and TX/RX power of the SS during the initial connection of the SS to the BS. An AAS Broadcast Capability field indicates whether the SS can receive a broadcast message.

Upon receipt of the above Ranging Request message from the SS, the serving BS transmits a Ranging Response message to the SS in step 207 as described above. FIG. 6 is a diagram illustrating the format of the Ranging Response message that is transmitted from a BS to an MS in the IEEE 802.16e system. The format of the Ranging Response message will now be described with reference to FIG. 6.

Referring to FIG. 6, a Management Message Type field has a value of ‘5’ to indicate that the present message is a Ranging Response message. An Uplink (UL) Channel ID field indicates which UL channel is used to receive a uplink channel message. A TLV encoded information field indicates encoded information including an SS Medium Access Control (MAC) Address, a Downlink Operational Burst Profile, a Primary Management Connection ID (CID), a Basic CID, a Ranging status, a timing adjust, a power level adjust and a downlink frequency override. An SS MAC Address field contains a MAC layer address of the SS that will receive the Ranging Response message. A Downlink Operational Burst Profile field contains 2-byte data. The Downlink Operational Burst profile field is used as a response to the Requested Downlink Burst Profile field of the Ranging Request message from the SS and indicates a DIUC number that will be used by the BS. A Primary Management Connection ID (CID) field and a Basic CID field contain CIDs that the BS allocates to the SS. The CIDs are continuously used to manage connection between the BS and the SS during the service period of the SS after completion of a connection process following the ranging process. A Ranging Status field is used as a response of the BS to the Ranging Request message of the SS. When the Ranging Status field has a value of ‘1’, it indicates the need to continue the ranging process. When the Ranging Status field has a value of ‘2’, it indicates the need to abort (stop) the ranging process. When the Ranging Status field has a value of ‘3’, it indicates the success of the ranging process. When the Ranging Status field has a value of ‘4’, it indicates the need to perform the ranging request again (i.e., the need to perform a “reranging” process). A Timing Adjust field contains information that enables the SS to correct incorrect time information. A Power Level Adjust field contains information that enables the SS to adjust its TX/RX power. A Downlink Frequency Override field is used to inform the MS of a frequency value of another channel, so that the MS can again perform an initial ranging request with another frequency when the Ranging Status field is set to a value of ‘2’ indicating the need to abort the ranging process.

Upon receipt of the above Ranging Response message from the serving BS, the SS detects the value of the Ranging Status field of the Ranging Response message. When the Ranging Status field value is ‘1’ or 4, the MS adjusts time information or TX power and performs a ranging request again. The ranging process continues until a Ranging Success message is received from the serving BS, that is, until the Ranging Status field value is set to ‘3’.

However, the ranging process between an SS and a BS is difficult to perform in multi-hop relay environments. The reason for this is that a Ranging Request message of the SS is transmitted to the BS via the RS and thus the Ranging Request message contains information that cannot be processed by the BS. That is, because the BS indirectly communicates with the MS, the BS cannot process information other than the Basic CID and the Primary Management CID among the contents of the Ranging Request/Ranging Response messages that are directly exchanged between the SS and the BS. Typical examples of the information, which cannot be processed by the BS, are Burst Profile information and the Power Adjust information that must be referred to for communication on a physical channel. The RS receives a Ranging Request message from the SS and transmits the Ranging Request message to the serving BS without changing the Ranging Request message. In this case, the BS cannot process the information for the typical examples because it is not a node in direct communication with the MS. With the RS directly communicating with the SS, and not the BS, the RS can process the information for the typical examples by detecting the TX power and time information of the SS. Accordingly, it is impossible for the serving BS to process the Ranging Request message using the existing technologies.

When the RS transmits the Ranging Request message to the serving BS without a change thereof and transmits the Ranging Request Response message to the MS without a change thereof in a multi-hop relay BWA system, the ranging process cannot be performed normally. What is therefore required is to implement additional operations that must be performed in the ranging process between the SS and the BS.

### SUMMARY OF THE INVENTION

An object of the present invention is to substantially solve at least the above problems and/or disadvantages and to provide at least the advantages below. Accordingly, an object of the present invention is to provide an apparatus and method for relaying Ranging messages in a multi-hop relay BWA system, the apparatus including an MS, a serving BS, and an RS that enables Ranging Request/Ranging Response messages to be suitably transmitted between the MS and the serving BS.

Another object of the present invention is to provide an RS and a method for relaying Ranging messages in a multi-hop relay BWA system, which reconfigures a Ranging Request message received from an MS into a Relay Ranging Request message and transmits the Relay Ranging Request message to a serving BS.

A further object of the present invention is to provide an RS and a method for relaying Ranging messages in a multi-hop relay BWA system, which reconfigures a Ranging Response message received from a serving BS into a Relay Ranging Response message and transmits the Relay Ranging Response message to an MS.

According to one aspect of the present invention, there is provided an RS installed between an MS and a serving BS. Upon receipt of a Ranging Request message from the MS, the RS reconfigures the Ranging Request message into a Relay Ranging Request message and transmits the Relay Ranging Request message to the serving BS. Upon receipt of the Relay Ranging Request message from the RS, the serving BS reconfigures the Relay Ranging Request message into a Relay Ranging Response message and transmits the Relay Ranging Response message to the RS. Upon receipt of the Relay Ranging Response message from the serving BS, the RS reconfigures the Relay Ranging Response message into a Ranging Response message and transmits the Ranging Response message to the MS.

According to another aspect of the present invention, there is provided an RS for a multi-hop relay BWA system, the RS including a Relay Ranging Request message processor for receiving a Ranging Request message from an MS, reconfiguring the received Ranging Request message into a Relay Ranging Request message, and transmitting the Relay Ranging Request message to a serving BS; and a Ranging Response message processor for receiving a Relay Ranging Response message from the serving BS, reconfiguring the Relay Ranging Response message into a Ranging Response message, and transmitting the Ranging Response message to the MS.

According to a further aspect of the present invention, there is provided an apparatus for relaying Ranging messages in a multi-hop relay BWA system, the apparatus including an MS for transmitting a Ranging Request message to an RS and receiving a Ranging Response message from the RS; the RS for reconfiguring the Ranging Request message received from the MS into a Relay Ranging Request message to transmit the Relay Ranging Request message to a serving BS, and reconfiguring a Relay Ranging Response message received from the serving BS into the Ranging Response message to transmit the Ranging Response message to the MS; and the serving BS for reconfiguring the Relay Ranging Request received from the RS into the Relay Ranging Response message and transmitting the Relay Ranging Response message to the RS.

According to an additional aspect of the present invention, there is provided a method for relaying Ranging messages in a multi-hop relay BWA system, the method including transmitting a Ranging Request message from an MS to an RS; reconfiguring, at the RS, the Ranging Request message into a Relay Ranging Request message and transmitting the Relay Ranging Request message from the RS to a serving BS; transmitting a Relay Ranging Response message from the serving BS to the RS; and reconfiguring, at the RS, the Relay Ranging Response message into a Ranging Response message and transmitting the Ranging Response message from the RS to the MS.

### BRIEF DESCRIPTION OF THE DRAWINGS

The above and other objects, features and advantages of the present invention will become more apparent from the following detailed description when taken in conjunction with the accompanying drawings in which:

FIG. 1 is a schematic block diagram of an IEEE 802.16e system;

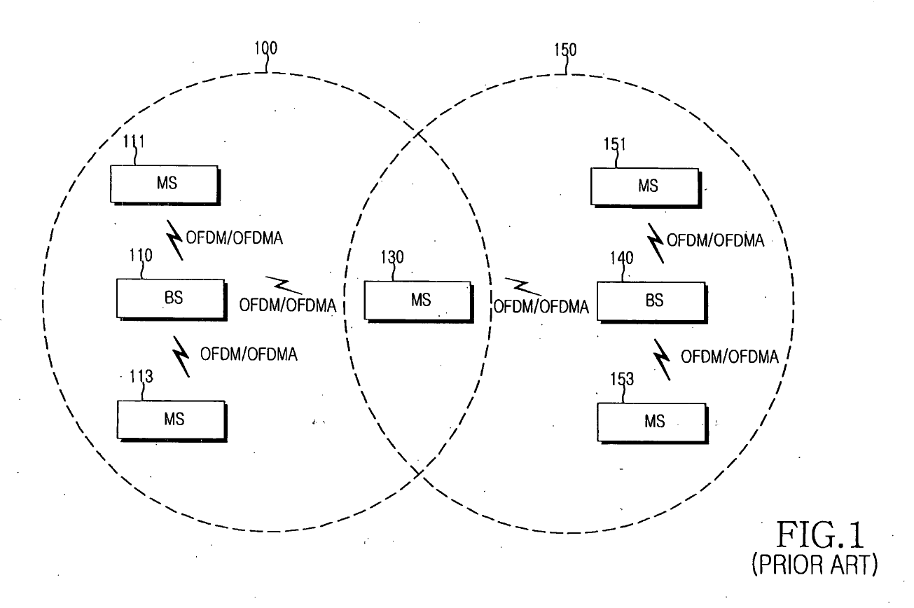

FIG. 2 is a message flow diagram illustrating a ranging procedure in the IEEE 802.16e system;

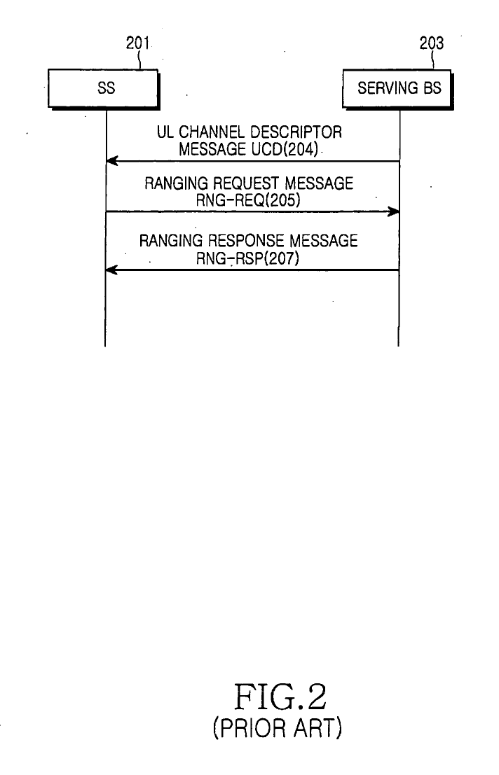

FIG. 3 is a schematic diagram of a wireless communication system for performing a ranging procedure using an RS according to the present invention;

FIG. 4 is a message flow diagram illustrating a ranging procedure using an RS according to the present invention;

FIG. 5 is a diagram illustrating the format of a Ranging Request message that is transmitted from an SS to a BS in the IEEE 802.16e system;

FIG. 6 is a diagram illustrating the format of a Ranging Response message that is transmitted from a BS to an SS in the IEEE 802.16e system;

FIG. 7 is a diagram illustrating the format of a Relay Ranging Request message that is transmitted from an RS to a serving BS according to the present invention;

FIG. 8 is a diagram illustrating the format of a Relay Ranging Response message that is transmitted from a serving BS to an RS according to the present invention;

FIG. 9 is a diagram illustrating the format of a Relay Ranging Request message that is transmitted from an RS to a serving BS according to the present invention;

FIG. 10 is a diagram illustrating the format of a Relay Ranging Response message that is transmitted from a serving BS to an RS according to the present invention;

FIG. 11 is a diagram illustrating the format of a Ranging Response message that is transmitted from an RS to an MS according to the present invention;

FIG. 12 is a flowchart illustrating a procedure that is performed at an RS to receive/transmit a Ranging Request message/a Ranging Response message from/to an MS according to the present invention;

FIG. 13 is a flowchart illustrating a procedure that is performed at a serving BS to receive/transmit a Relay Ranging Request message/a Relay Ranging Response message from/to an RS according to the present invention; and

FIG. 14 is a flowchart illustrating a procedure that is performed at a serving BS or an RS in relation to ranging status codes in the Ranging Response message of FIG. 11 according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and method for relaying Ranging messages in a multi-hop relay BWA system. An RS is disposed between an MS and a serving BS. Upon receipt of a Ranging Request message from the MS, the RS reconfigures the Ranging Request message into a Relay Ranging Request message and transmits the Relay Ranging Request message to the serving BS. Upon receipt of the Relay Ranging Request message from the RS, the serving BS reconfigures the Relay Ranging Request message into a Relay Ranging Response message and transmits the Relay Ranging Response message to the RS. Upon receipt of the Relay Ranging Response message from the serving BS, the RS reconfigures the Relay Ranging Response message into a Ranging Response message and transmits the Ranging Response message to the MS.

The multi-hop relay BWA system uses an OFDM/OFDMA scheme. Accordingly, the multi-hop relay BWA system can transmit physical channel signals using a plurality of subcarriers, thereby enabling high-rate data transmission. In addition, the multi-hop relay BWA system supports a multi-cell structure, thereby supporting the mobility of an MS.

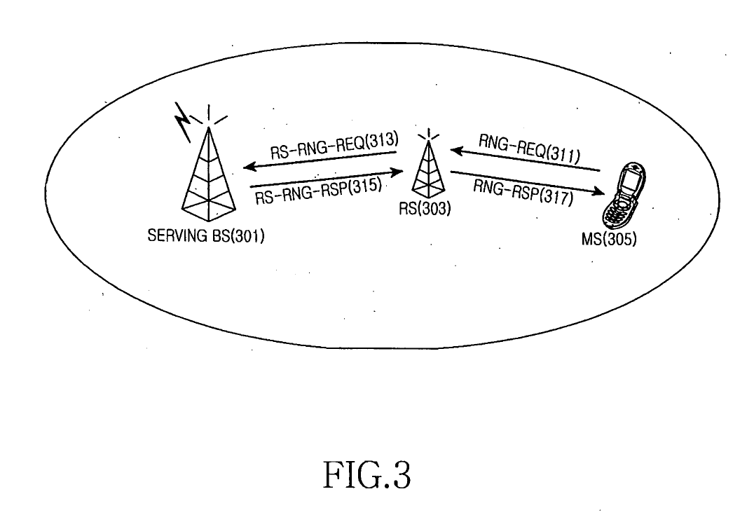

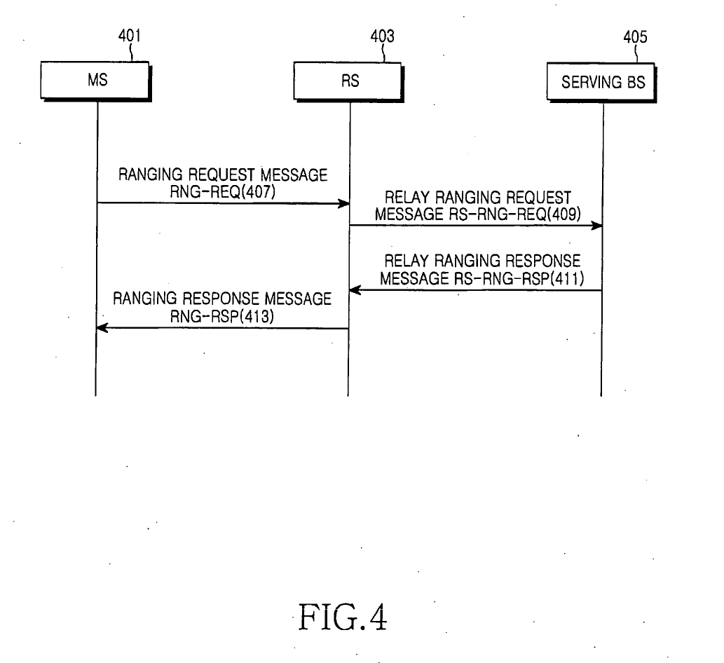

FIG. 3 is a schematic diagram of a wireless communication system for performing a ranging procedure using an RS according to the present invention. FIG. 4 is a message flow diagram illustrating a ranging procedure using an RS according to the present invention.

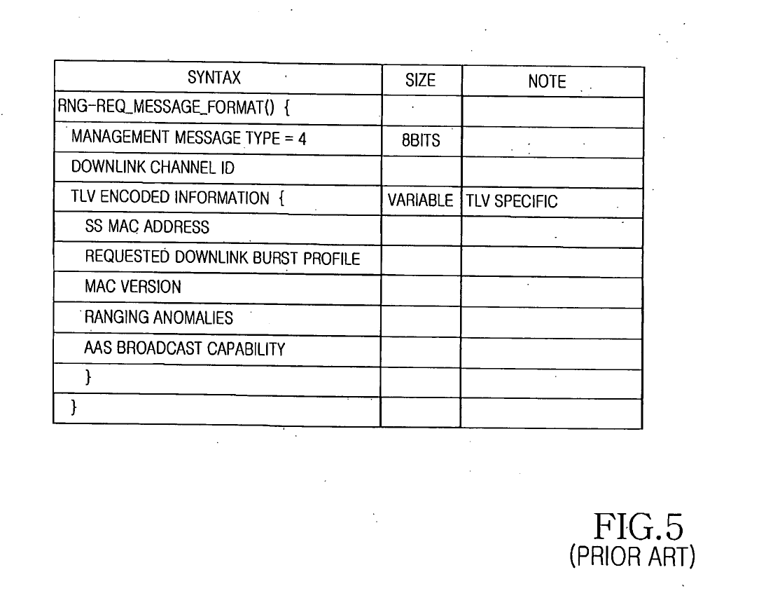

Referring to FIGS. 3 and 4, an MS 305 (labeled as 401 in FIG. 4) transmits a Ranging Request message RNG-REQ 311 (labeled as 407 in FIG. 4) to an RS 303 (labeled as 403 in FIG. 4). The Ranging Request message RNG-REQ 311 (407) has the same structure as that of the conventional Ranging Request message illustrated in FIG. 5. The Ranging Request message contains information necessary in a physical layer for communication between an MS and a BS, and the MAC Address field contains MS specific information of a MAC layer, which is used by a BS to identify an MS.

The RS may be an infrastructure RS or a client RS. An infrastructure RS is a fixed RS that is installed by a communication service provider, while a client RS is a mobile RS such as an MS that acts as an RS for another MS.

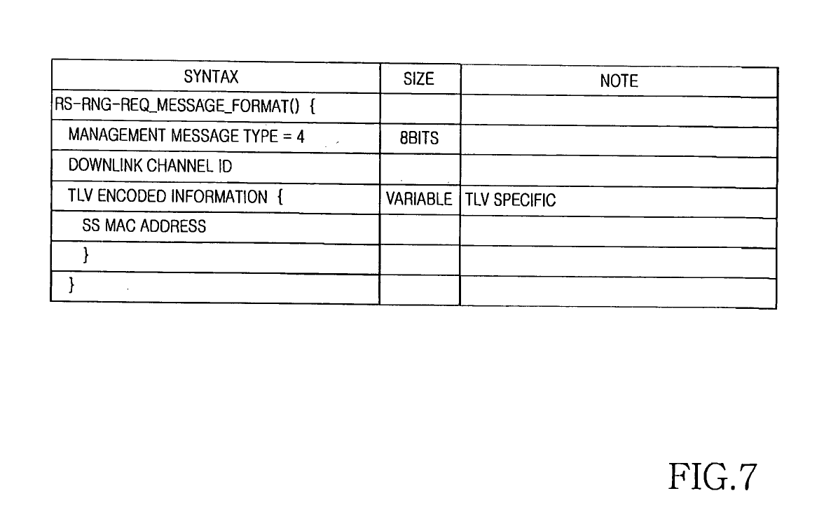

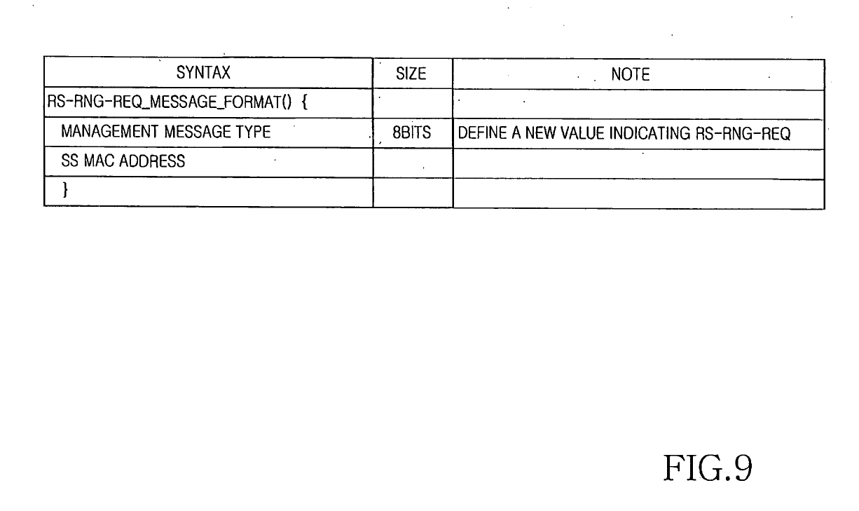

Upon receipt of the Ranging Request message RNG-REQ 311 (407), the RS reconfigures the Ranging Request message 311 (407) into a Relay Ranging Request message RS-RNG-REQ 313 (409) and transmits the Relay Ranging Request message RS-RNG-REQ 313 (409) to a Serving BS 301 (405). The format of the Relay Ranging Request message RS-RNG-REQ 313 (409) will be described later with reference to FIGS. 7 and 9.

The RS 303 (403) substantially processes the Ranging Request message 311 (407) received from the MS 305 (401). As described above, the Ranging Request message mostly contains information necessary in a physical layer for communication between an MS and a corresponding communication node. In addition, when an MS communicates with a BS through a multi-hop relay node instead of communicating directly with a BS, a node that actually communicates with the MS is not a BS but an RS. Therefore, the RS itself, and not the BS, enables the MS to acquire physical channel information for communication so as to perform a successful ranging process. Accordingly, the RS 303 (403) itself can substantially process and respond to the received Ranging Request message without the need to transmit the Ranging Request message to the serving BS.

However, the ranging process must include: reconfiguring the Ranging Request message into a Ranging Response message; and transmitting the Ranging Response message containing CIDs of the MS to the MS thereby allocating the CIDs to the MS. The CIDs are a basic CID and a primary management CID. Therefore, most of the ranging process can be performed by the RS, but the CIDs can be allocated only by the serving BS.

In the ranging process according to the present invention, the RS performs all the ranging process, except the allocation of the CIDs, when it receives the Ranging Request message from the MS. The RS requests and receives the CIDs from the serving BS, configures a Ranging Response message containing the received CIDs, and transmits the configured Ranging Response message to the MS.

Although not illustrated in the accompanying drawings, the RS may include a Relay Ranging Request message processor and a Ranging Response message processor. The Relay Ranging Request message processor reconfigures a Ranging Request message received from an MS into a Relay Ranging Request message and transmits the Relay Ranging Request message to a serving BS. The Ranging Response message processor reconfigures a Relay Ranging Response message received from the serving BS into a Ranging Response message and transmits the Ranging Response message to the MS.

FIG. 7 is a diagram illustrating the format of the Relay Ranging Request message RS-RNG_REQ 313 (409) transmitted from the RS 303 (403) to the serving BS 301 (405) according to the present invention.

Referring to FIG. 7, the Relay Ranging Request message RS-RNG_REQ 313 (409) has a smaller size the conventional Relay Ranging Request message illustrated in FIG. 5. That is, the Relay Ranging Request message RS-RNG_REQ 313 (409) is configured to include the remaining fields except the fields that can be processed by the RS 303 (403). In FIG. 7, a Downlink Channel ID may be replaced by a Basic Channel ID. In this case, the RS transmits a message containing only a MAC address of the MS to the serving BS, and the serving BS receives the message containing only the MAC address and recognizes the received message as the RS Ranging Request message.

FIG. 9 is a diagram illustrating the format of the Relay Ranging Request message RS-RNG_REQ 313 (409) transmitted from the RS 303 (403) to the serving BS 301 (405) according to another embodiment of the present invention.

Referring to FIG. 9, a Management Message Type field is newly defined using a new 8-bit value indicating a Relay Ranging Request message and only the MAC address of the MS is contained in the Relay Ranging Request message. This is done to further reduce the size of a Relay Ranging Request message.

Upon receipt of the Relay Ranging Request message RS-RNG-REQ 313 (409) from the RS 303 (403), the serving BS 301 (405) reconfigures the Relay Ranging Request message into a Relay Ranging Response message RS-RNG-RSP 315 (411) and transmits the Relay Ranging Response message to the RS 303 (403).

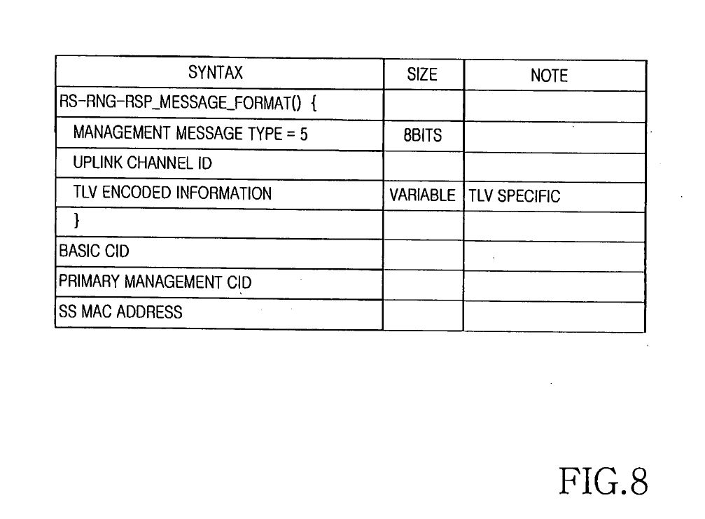

FIG. 8 is a diagram illustrating the format of a Relay Ranging Response message that is transmitted from a serving BS to an RS according to the present invention. That is, FIG. 8 illustrates the format of a Relay Ranging Response message corresponding to the Relay Ranging Request message of FIG. 7.

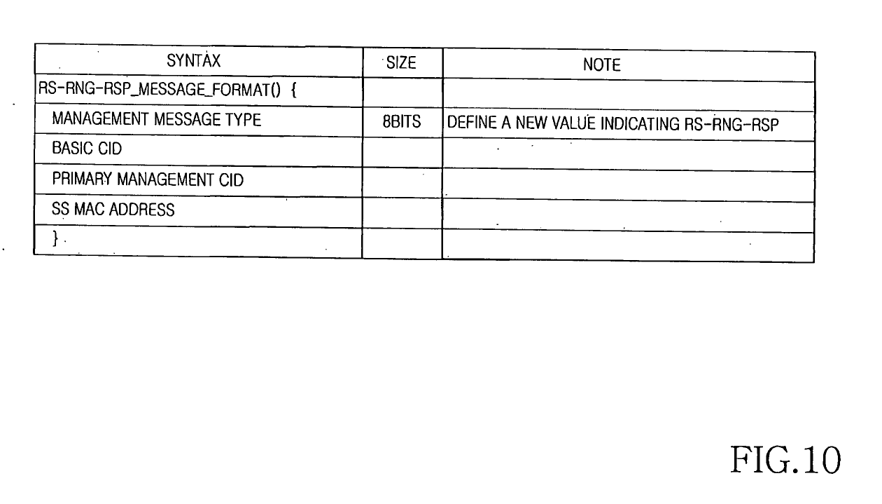

FIG. 10 is a diagram illustrating the format of a Relay Ranging Response message that is transmitted from a serving BS to an RS according to the other embodiment of the present invention. That is, FIG. 10 illustrates the format of a Relay Ranging Response message corresponding to the Relay Ranging Request message of FIG. 9.

Upon receipt of the Relay Ranging Response message RS-RNG-RSP 315 (411) from the serving BS 301 (405), the RS 303 (403) reconfigures the Relay Ranging Response message into a Ranging Response message RNG-RSP 317 (413) and transmits the Ranging Response message to the MS 305 (401).

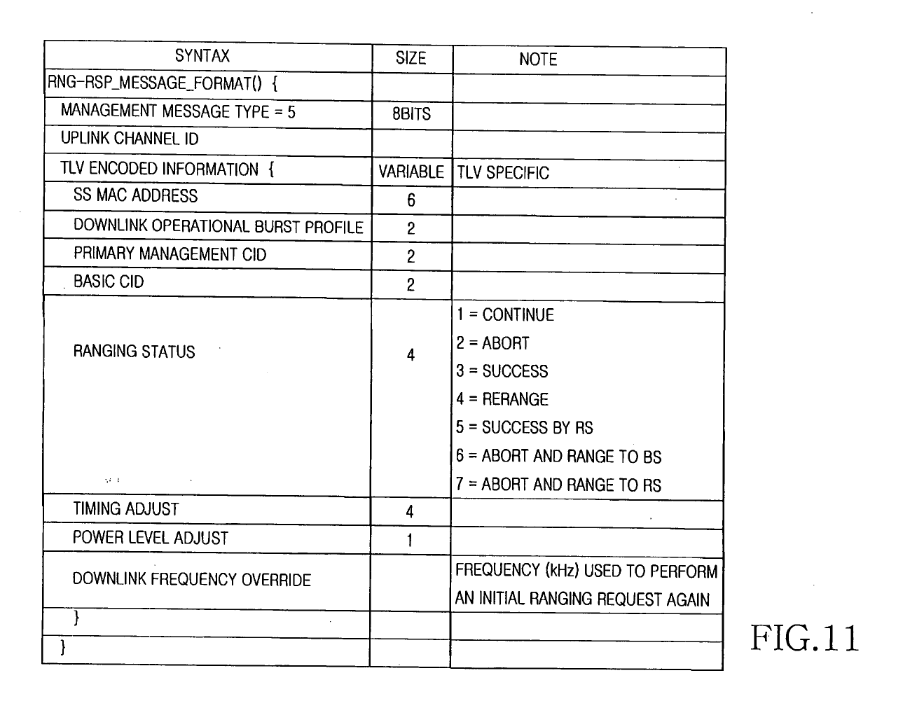

FIG. 11 illustrates the format of the Ranging Response message RNG-RSP 317 (413) according to the present invention. The Ranging Response message format illustrated in FIG. 11 can be used both in a case where the MS transmits a Ranging Request message to the RS and in a case where the MS transmits a Ranging Request message directly to the serving BS.

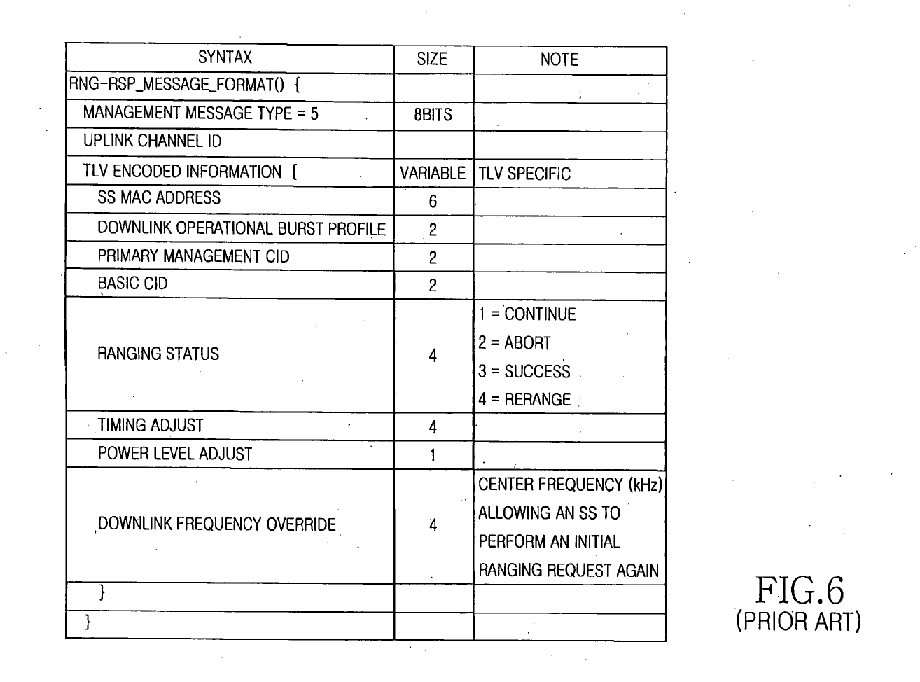

Except for a Ranging Status field, the format of the Ranging Response message illustrated in FIG. 11 is identical to the format of the conventional Ranging Response message illustrated in FIG. 6. The Ranging Status field of the Ranging Response message in FIG. 11 further contains field values 5, 6 and 7 in addition to field values 1, 2, 3 and 4 that are identical to those in FIG. 6. The field values 5, 6 and 7 are added to provide the following functions.

Ranging Status=5: This indicates the success of a ranging process through the RS, while “Ranging Status=3” indicates the success of a ranging process through the serving BS.

Ranging Status=6: This is selectively used by the RS. In this case, the RS aborts the Ranging process and attempts to connect to the BS using frequency information provided in a Downlink Frequency Override field. When receiving a Ranging Response message with a Ranging Status value of ‘6’, the MS detects that a corresponding ranging connection is performed by the RS. Accordingly, the MS aborts an ongoing ranging process and ranges to the BS using a center frequency defined in the Downlink Frequency Override field.

Ranging Status=7: This is used when the MS transmits a Ranging Request message to the BS, not to the RS, and the BS commands the MS to transmit a Ranging Request message to the RS. When receiving a Ranging Response message with a Ranging Status value of ‘7’, the MS aborts an ongoing ranging process and ranges to the RS using a center frequency defined in the Downlink Frequency Override field.

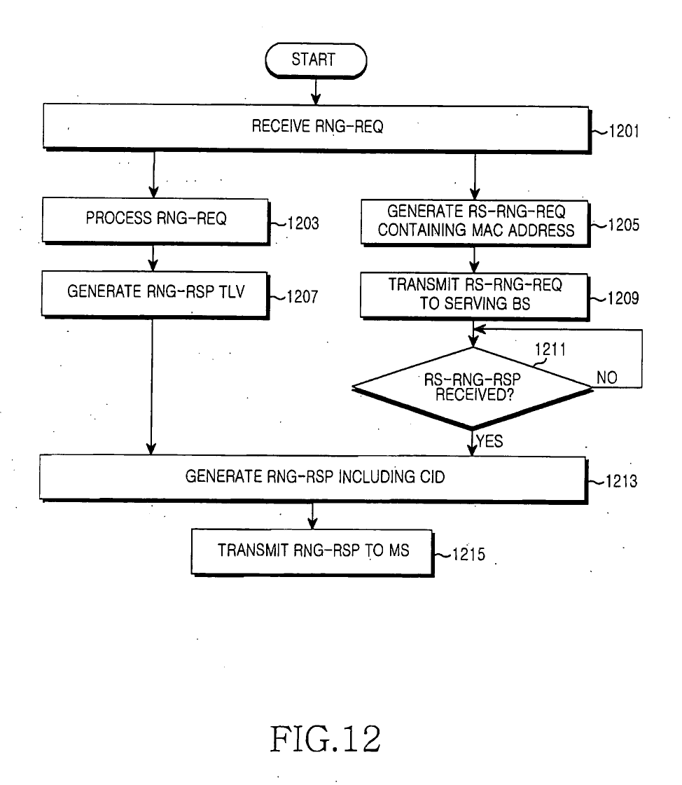

FIG. 12 is a flowchart illustrating a procedure that is performed at an RS to receive/transmit a Ranging Request message/a Ranging Response message from/to an MS according to the present invention.

Referring to FIG. 12, an RS receives a Ranging Request message RNG-REQ from an MS in step 1201. In step 1205, the RS reconfigures the Ranging Request message into a Relay Ranging Request message RS-RNG-REQ containing a MAC address in step 1205. The Relay Ranging Request message has a format illustrated in FIG. 7 or FIG. 9. Thereafter, the RS transmits the Relay Ranging Request message to a serving BS in step 1209 and determines if a Relay Ranging Response message is received from the serving BS in step 1211. The Relay Ranging Response message has a format illustrated in FIG. 8 or FIG. 10. In addition, the RS processes the Ranging Request in step 1203, generates a RNG-RSP type length value (TLV) in step 1207, generates a Ranging Response message RNG-RSP containing the TLV and the CID of the Relay Ranging Response message in step 1213, and transmits the Ranging Response message to the MS in step 1215.

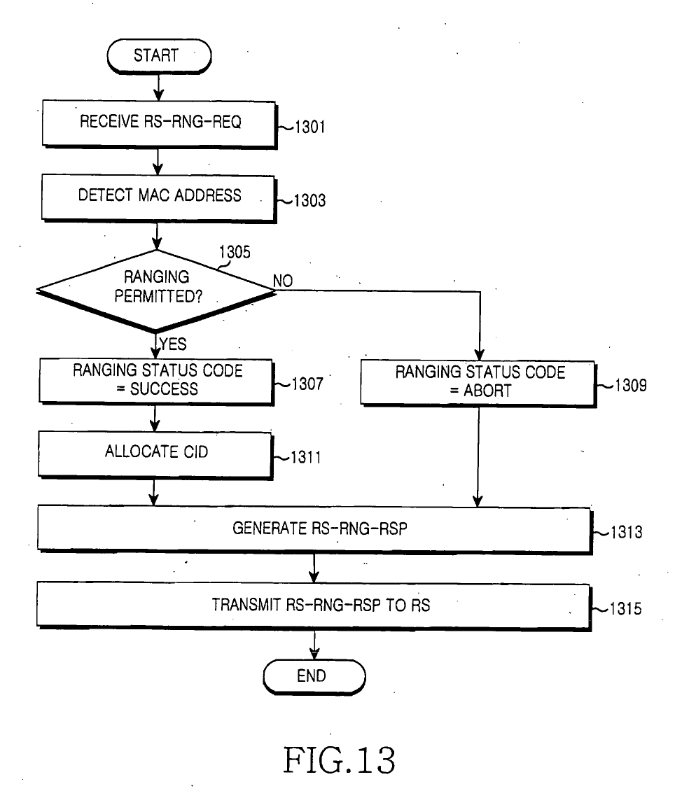

FIG. 13 is a flowchart illustrating a procedure that is performed at a serving BS to receive/transmit a Relay Ranging Request message/Relay Ranging Response message from/to an RS according to the present invention.

Referring to FIG. 13, a serving BS receives a Relay Ranging Request message RS-RNG-REQ from an RS in step 1301. In step 1303, the serving BS detects a MAC address from the Relay Ranging Request message. In step 1305, the serving BS determines whether to accept the ranging request. If the Ranging Request is accepted, the serving BS sets a Ranging Status code to SUCCESS in step 1307, allocates a CID in step 1311, generates a Relay Ranging Response message in step 1313, and transmits the Relay Ranging Response message to the RS in step 1315. On the other hand, if the Ranging Request is not accepted, the serving BS sets a corresponding Ranging Status code in step 1309, generates a Relay Ranging Response message in step 1313, and transmits the Relay Ranging Response message to the RS in step 1315.

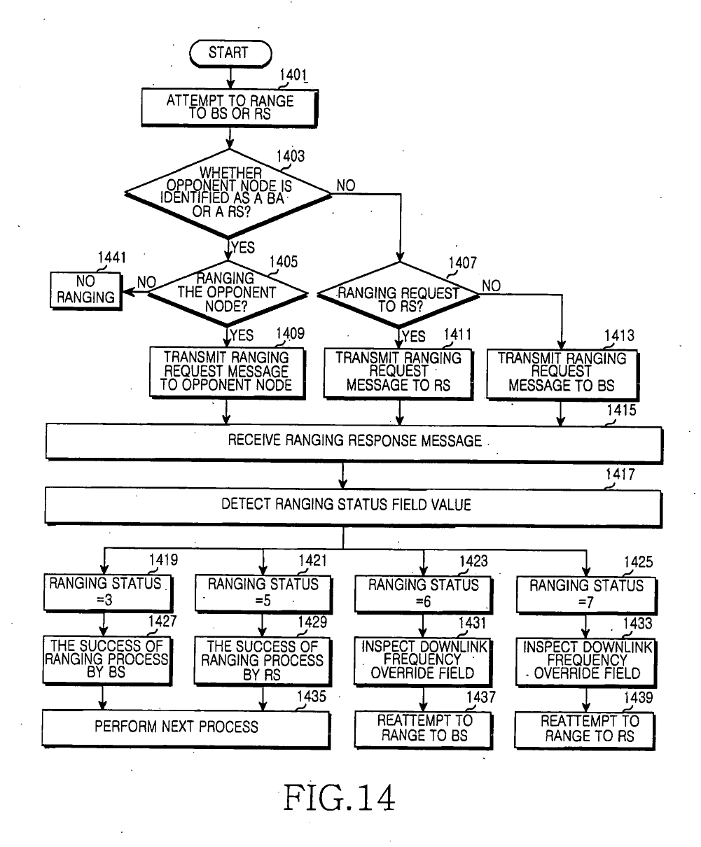

FIG. 14 is a flowchart illustrating a procedure that is performed at a serving BS or an RS in relation to Ranging Status codes in the Ranging Response message of FIG. 11 according to the present invention.

Referring to FIG. 14, an MS attempts to range to a serving BS or an RS in step 1401. In steps 1403, 1405, 1407, 1409, 1411 and 1413, the MS transmits a Ranging Request message to the RS or the serving BS. Thereafter, the MS receives a Ranging Response message to the Ranging Request message in step 1415 and detects a ranging status field value in step 1417.

If the Ranging Status field value is ‘3’ (step 1419), the MS detects the success of the ranging operation through the serving BS in step 1427, and performs the next process in step 1435.

If the Ranging Status field value is ‘5’ (step 1421), the MS detects the success of the ranging operation through the RS in step 1429, and performs the next process in step 1435.

If the Ranging Status field value is ‘6’ (step 1423), the MS detects the need to abort a ranging process using the RS, detects a center frequency defined in a Downlink Frequency Override field in step 1431, and reattempts to range to a BS using the center frequency in step 1437.

If the Ranging Status field value is ‘7’ (step 1425), the MS detects the need to abort a ranging process using the serving BS, detects a center frequency defined in a Downlink Frequency Override field in step 1433, and reattempts to range to an RS using the center frequency in step 1439.

In 1405 step, if a ranging to the opponent node is not selected, the ranging is not performed.

In the multi-hop relay BWA system according to the present invention, the RS receives the Ranging Request message from the MS, reconfigures the Ranging Request message into the Relay Ranging Request message, and transmits the Relay Ranging Request message to the serving BS. Thereafter, the RS receives the Relay Ranging Response message from the serving BS, reconfigures the Relay Ranging Response message into the Ranging Response message, and transmits the Ranging Response to the MS. Accordingly, the use of the present invention saves radio resources and increases the speed of the ranging process.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A relay station (RS) for a wireless access system, comprising:
a Relay Ranging Request message processor for receiving a Ranging Request message from a Mobile Station (MS), reconfiguring the received Ranging Request message into a Relay Ranging Request message, and transmitting the Relay Ranging Request message to a serving Base Station (BS); and
a Ranging Response message processor for receiving a Relay Ranging Response message from the serving BS, reconfiguring the Relay Ranging Response message into a Ranging Response message, and transmitting the Ranging Response message to the MS.

2. The relay station of claim 1, wherein the Relay Ranging Request message processor determines whether information in fields of the Ranging Request message may be processed to reconfigure the Ranging Request message into the Relay Ranging Request message.

3. The relay station of claim 2, wherein the information processible by the Relay Ranging Request message processor includes Power Adjust information and Burst Profile information necessary for communication on a physical channel.

4. The relay station of claim 1, wherein the RS is one of an infrastructure RS and a client RS.

5. The relay station of claim 1, wherein the Ranging Response message includes a Ranging Status field and the Ranging Response message processor loads information, which indicates that part of fields in the Ranging Response message has been processed by the relay station, into the Ranging Status field.

6. The relay station of claim 1, wherein the Ranging Response message processor loads information, which indicates the need to transmit the next ranging request message to another serving BS, into the Ranging Response message.

7. An apparatus for relaying Ranging messages in a wireless access system, the apparatus comprising:
a Mobile Station (MS) for transmitting a Ranging Request message to a Relay Station (RS) and receiving a Ranging Response message from the RS;
the RS for reconfiguring the Ranging Request message received from the MS into a Relay Ranging Request message to transmit the Relay Ranging Request message to a serving Base Station (BS), and reconfiguring a Relay Ranging Response message received from the serving BS into the Ranging Response message to transmit the Ranging Response message to the MS; and
the serving BS for reconfiguring the Relay Ranging Request received from the RS into the Relay Ranging Response message and transmitting the Relay Ranging Response message to the RS.

8. The apparatus of claim 7, wherein the RS determines whether information in fields of the Ranging Request message may be processed to reconfigure the Ranging Request message into the Relay Ranging Request message.

9. The apparatus of claim 8, wherein the information processible by the RS includes Power Adjust information and Burst Profile information necessary for communication on a physical channel.

10. The apparatus of claim 7, wherein the RS is one of an infrastructure RS and a client RS.

11. The apparatus of claim 7, wherein the Ranging Response message includes a Ranging Status field and the RS loads information, which indicates that part of fields in the Ranging Response message has been processed by the RS, into the Ranging Status field.

12. The apparatus of claim 7, wherein the RS loads information, which indicates the need to transmit the next ranging request message to another serving BS, into the Ranging Response message.

13. A method for relaying Ranging messages in a wireless access system, the method comprising the steps of:
transmitting a Ranging Request message from a Mobile Station (MS) to a Relay Station (RS);
reconfiguring, at the RS, the Ranging Request message into a Relay Ranging Request message and transmitting the Relay Ranging Request message from the RS to a serving Base Station (BS);
transmitting a Relay Ranging Response message from the serving BS to the RS; and
reconfiguring, at the RS, the Relay Ranging Response message into a Ranging Response message and transmitting the Ranging Response message from the RS to the MS.

14. The method of claim 13, wherein, during the step of transmitting the Relay Ranging Request message to the serving BS, the RS determines whether information in fields of the Ranging Request message may be processed to reconfigure the Ranging Request message into the Relay Ranging Request message.

15. The method of claim 14, wherein the information processible by the RS includes Power Adjust information and Burst Profile information necessary for communication on a physical channel.

16. The method of claim 13, wherein the RS is one of an infrastructure RS and a client RS.

17. The method of claim 13, wherein the Ranging Response message includes a Ranging Status field that contains information indicating that part of fields in the Ranging Response message has been processed by the RS.

18. The method of claim 13, wherein the Ranging Response message includes information that indicates the need to transmit the next ranging request message to another serving BS.
